(19) United States
(12) Patent Application Publication
(10) Pub. No.: US 2002/0173286 A1
(43) Pub. Date: Nov. 21, 2002

(54) Radiocommunication employing selected synchronization technique

(76) Inventors: Bengt Lindoff, Bjarred (SE); Jakob Singvall, Lund (SE)

Correspondence Address: Ronald L. Grudziecki, BURNS, DOANE, SWECKER & MATHIS, L.L.P, P.O. Box 1404, Alexandria, VA, 22313-1404, US

(21) Appl. No.: 09/826,967

(22) Filed: Apr. 6, 2001

(51) Int. Cl. H04B 1/10

(52) U.S. Cl. 455/295; 455/323; 455/334

(57) ABSTRACT

A method and apparatus for acquiring time synchronization to a received signal are described. First, a burst of data which includes a known sequence is received. This received signal is processed using a plurality of different synchronization techniques. Each synchronization technique can be paired with a corresponding channel estimation technique, which pairing is predetermined to be optimized for particular channel conditions. A processor or model validation unit selects the channel estimate associated with the channel conditions currently being experienced by the radio signal.

### BACKGROUND

The field of the invention relates to synchronization of signals and, in particular, to a method and system for selecting a particular technique for synchronizing to a radio signal based on radio channel conditions.

The cellular telephone industry has made phenomenal strides in commercial operations in the United States as well as the rest of the world. Growth in major metropolitan areas has far exceeded expectations and is rapidly outstripping system capacity. If this trend continues, the effects of this industry's growth will soon reach even the smallest markets. Innovative solutions are required to meet these increasing capacity needs as well as maintain high quality service and avoid rising prices.

In mobile communication, the transmitted signal is often subjected to a time smearing effect created by the time dispersive nature of the channel, i.e., the air interface between a base station and a mobile station. This time smearing effect is also sometimes referred to as intersymbol interference (ISI). The channel effects are estimated in the receiver part of a communication system, and used by the detector to aid in attempting to correctly deduce the information symbols that were transmitted thereto.

In a digital cellular system, “symbols” are sent out from a transmitter, e.g. a mobile phone. A symbol in this case, e.g., systems as defined by the Global System for Mobile Communications (GSM) or Enhanced Data Rates for Global Evolution (EDGE), can be seen as a complex-valued number, where the information resides in the phase angle. GSM has defined 1 bit symbols with possible phase angles of 0 and π radians. EDGE has defined 3 bit symbols, with possible phase angles of 0, π/4, π/2, 3π/4, π, 5π/4, 3π/2 and 7π/4 radians, respectively.

When sending a symbol, a pulse-shaped waveform is transmitted in the air. The symbol rate in both GSM and EDGE systems is 270,833 symbols per second, therefore, new symbol “pulses” will be created by the transmitter each 3.7 μs. A transmitted symbol pulse is split into several rays during its travel though the air which phenomena is referred to as multi-path propagation. Different rays typically travel along different paths on their way between transmitter and receiver antennas. Examples of items that cause multi-path distortion are reflections because of hills, buildings, vehicles etc. On the receiving side (e.g. a base station), the symbols will be detected thru complex-valued measurements of the received rays.

As an extreme example, e.g., in hilly terrain, consider that a specific symbol is smeared over 30 μs, i.e., about eight times the original symbol period. To reconstruct such symbols the receiver can make measurements, Y(i), which contain a weighted sum of 8 transmitted symbols, S(i-k):

Y(i)=ΣH(k)*S(i−k); k=0 to 7;

wherein H(k) are the channel taps (complex-valued). Such a radio channel is often briefly referred to as an “8 tap channel.”

In order to time tune (“synchronize”) a receiver to a burst of received symbols, the position of a known data pattern within the burst is determined. In GSM systems, this pattern is referred to as a training sequence and is defined to be in the middle of each burst or timeslot. Normal Bursts (NB) in both GSM and EDGE contain a training sequence of 26 symbols as illustrated in FIG. 1, which symbols are complex-valued.

A primary issue confronting systems designers dealing with synchronization issues is determining, for example with respect to GSM systems and terminals, which group of 26 measurements performed on a received data burst at the receiver corresponds “best” to the 26 training sequence symbols. This issue gives rise to a number of different synchronization techniques which have been developed for confronting this challenge. For example, a simple correlation test can be performed wherein the received signals are compared to a locally generated version of the training sequence. The synchronization position is then determined to be that which provides the best correlation between the received signal and the locally generated version of the training sequence. While straightforward, this technique is susceptible to disturbances associated with changing radio channel conditions which generate a correlation peak which is relatively distant from the “true” synchronization position, thereby resulting in degraded receiver performance.

Accordingly, other synchronization techniques have been developed. For example, another conventional GSM synchronization system, which is described in U.S. Pat. No. 5,373,507 (the disclosure of which is incorporated here by reference), provides a variation on the straightforward correlation technique, which variation is referred to as the “center of gravity” or “center of energy” synchronization technique. This method, described in more detail below, seeks to avoid drawbacks associated with the straightforward application of correlation techniques.

In any event, regardless of which individual synchronization technique is employed in a receiver, the conventional processing of received signals is performed as illustrated in FIG. 2. Therein, a front-end portion 20 of a receiver converts a signal received via antenna 22 down to a baseband frequency. The output of the front-end portion 20 is fed into a synchronization unit 24 that, using a locally generated version of the training sequence (TS), identifies a synchronization position M associated with the received signal. The conventional receiver of FIG. 2 uses only a single synchronization technique in unit 24, e.g., either the correlation technique or the center of gravity technique referred to above. There may be a plurality of models used to estimate the channel effects, which models are employed in the channel estimator unit 26. The channel estimator unit 26 uses these models to generate channel estimates Hᵢ for all channel models i=1, . . . N. Then, a model validation unit 28 determines the best channel model for the current radio channel conditions and selects the corresponding channel estimate (and the corresponding synchronization position) for output to the equalizer 29. Equalizer 29 uses the channel estimate received from model validation unit 28 to detect the transmitted symbols by attempting to compensate for the channel effects or decode the received symbols.

One problem with this conventional receiver is that the synchronization technique employed by block 24 will not be optimal for all of the different radio channel conditions which are experienced by the receiver. This means that, at times, the receiver's performance will be degraded when it is operating under radio conditions for which its single synchronization technique is suboptimal. This is particularly true for homodyne (direct conversion) receivers which suffer from DC offset problems.

Accordingly, it would be desirable to provide a receiver with techniques for avoiding the synchronization problems discussed above.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

According to exemplary embodiments of the present invention, these and other problems, limitations and drawbacks of conventional receivers and signal processing techniques are overcome by the present invention wherein a plurality of synchronization techniques are available in a receiver for synchronizing to a received signal. These synchronization techniques can each be matched to a particular channel model and/or a particular training sequence. In this way, the varying channel conditions can be accounted for during synchronization such that the symbol detection process is not impaired when the channel conditions change.

The above features and advantages of the present invention will be more apparent and additional features and advantages of the present invention will be appreciated from the following detailed description of the invention made with reference to the drawings.

### BRIEF DESCRIPTION OF THE DRAWINGS

The present invention will now be described with reference to the following figures, in which:

FIG. 1 depicts a GSM timeslot burst format;

FIG. 2 illustrates a block diagram of a conventional radio receiver;

FIG. 3 illustrates a radiocommunication system in which the present invention can be implemented;

FIG. 4 is a correlation-time diagram of a conventional method for determining a synchronization group and a channel estimate;

FIG. 5 is a block diagram depiction of a receiver according to an exemplary embodiment of the present invention; and

FIG. 6 is a flowchart depicting an exemplary method for synchronization according to the present invention.

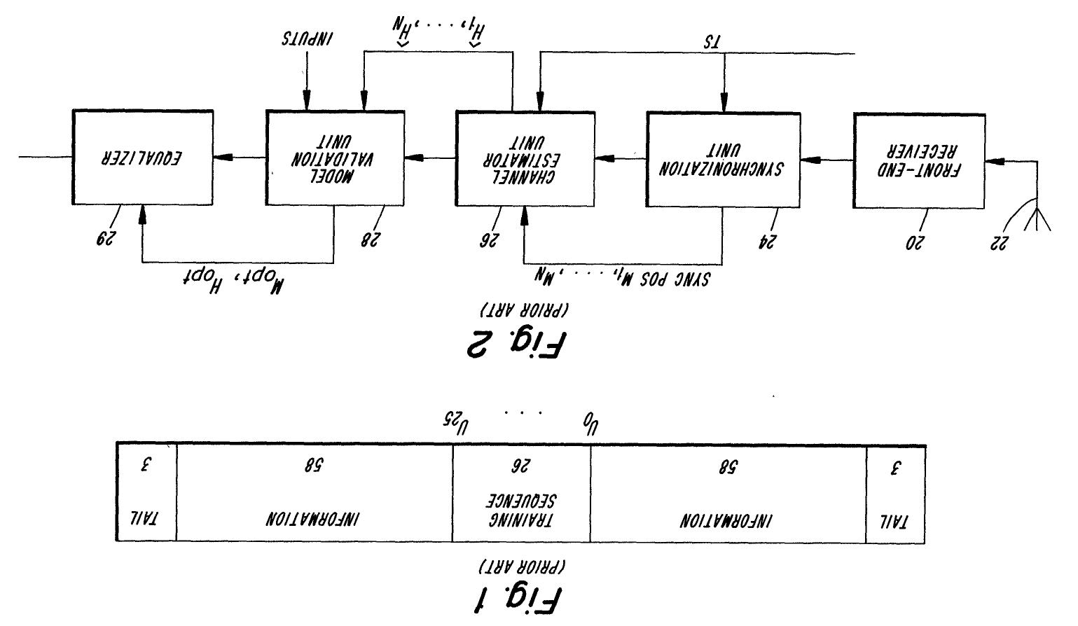

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention.

The exemplary radio communication systems discussed herein are based upon the time division multiple access (“TDMA ”) protocol, in which communication between the base station and the mobile terminals is performed over a number of time slots. However, those skilled in the art will appreciate that the concepts disclosed herein find use in other protocols, including, but not limited to, frequency division multiple access (“FDMA”), code division multiple access (“CDMA”), or some hybrid of any of the above protocols. Likewise, some of the exemplary embodiments provide illustrative examples relating to GSM types of radiocommunication systems; however, the techniques described herein are equally applicable to radio communication systems operating in accordance with any specification.

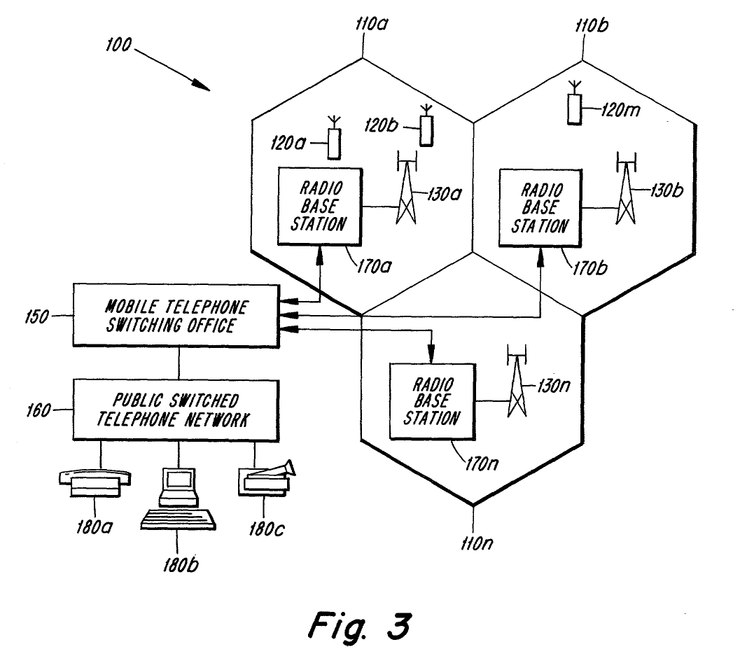

FIG. 3 is a block diagram of a general radio communication system in which an embodiment of the invention may be practiced. The radio communication system 100 of FIG. 3 includes a plurality of radio base stations 170a-n connected to a plurality of corresponding antennas 130a-n. The radio base stations 170a-n, in conjunction with the antennas 130a-n, communicate with a plurality of mobile terminals (e.g. terminals 120a, 120b, and 120m) within a plurality of cells 110a-n. Communication from a base station to a mobile terminal is referred to as the downlink, whereas communication from a mobile terminal to the base station is referred to as the uplink.

The base stations are connected to a mobile switching center (“MSC”) 150. Among other tasks, the MSC coordinates the activities of the base station, such as during the handoff of a mobile terminal from one cell to another. The MSC, in turn, can be connected to a public switched telephone network 160, which services various communication devices 180a, 180b, and 180c. Both the mobile terminals 120a, 120b, and 120m, and the base stations 170a-n can incorporate synchronization structures and techniques according to the present invention.

As a basis for discussing exemplary embodiments of the present invention, the correlation and center of gravity synchronization techniques will now be described in more detail.

Initially, correlations are performed between the received sequence and the locally generated version of the known sequence which is transmitted in the data burst. For example, the correlation can be generated as:

$$c ( k ) = {\sum }_{n}^{} r ( n + k ) t ( n ) , k = 0 … N$$

where

N is the synchronization window size

t(n) is the training sequence

r(n) are the received samples

Finding the sync position using the correlation synchronization method is then carried out as follows. Assuming the spread of adjacent symbols is i symbols, the accumulated power is obtained by summing the squared magnitude of c(k) over i symbols as:

$$energy ( k ) = {\sum }_{n = k}^{( k - t ) \geq 0} {\vert c ( n ) \vert}^{2} , k = 0 … N$$

The sync position is then selected as the k value which maximizes the value of energy (k).

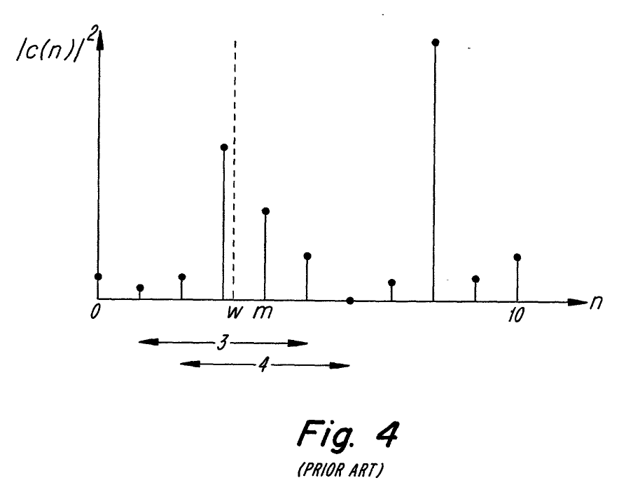

The center of gravity synchronization technique operates as follows. After receiving a burst of data, the receiver processes it in a number of different steps to acquire synchronization. In a first step, the center of energy of a first vector, having e.g., M correlation values between a synchronization sequence and M parts of a signal frame, which are partially overlapping and mutually displaced by one sampling interval, is calculated. For example, by taking five consecutive correlation values to form a first vector and then shifting attention to the next five consecutive sampling values, two vectors are obtained with partially the same elements which are time displaced by one sampling interval. FIG. 4 depicts a correlation-time diagram in which the sampling instances n run along the X-axis and the squared magnitudes of the correlations between the locally generated training sequence and the received signal run along the Y-axis. The center of energy w is calculated in accordance with the formula:

$$w = \frac{{\sum }_{k = 0}^{M - 1} k {\vert c ( k ) \vert}^{2}}{{\sum }_{k = 0}^{M - 1} {\vert c ( k ) \vert}^{2}}$$

where M is the number of correlation values e.g., 11. The obtained value is rounded to a preliminary window position m_{w} by rounding the obtained value w to the nearest integer.

In a second step a receiver employing the center of gravity technique determines the energy of the correlation values c(n) that are contained in two windows around this preliminary central window position in accordance with the formula:

$${E}_{n} = {\sum }_{j = - K}^{K} {\vert c ( j + {m}_{w} + n ) \vert}^{2} n = 0 , 1$$

where 2K+1=N, that is the number of correlation values in each window, for example, 5. In the example illustrated in FIG. 4 applying this technique will result in w being close to 3, the preliminary window center position will be rounded to 3, and two windows centered around positions 3 and 4 are compared with respect to energy contents. The coefficients c(n) of the window that has the largest energy content is output to the equalizer as a channel estimate. The final synchronization position m can be decided in several ways, e.g., by selecting the center position of the window with the largest energy content.

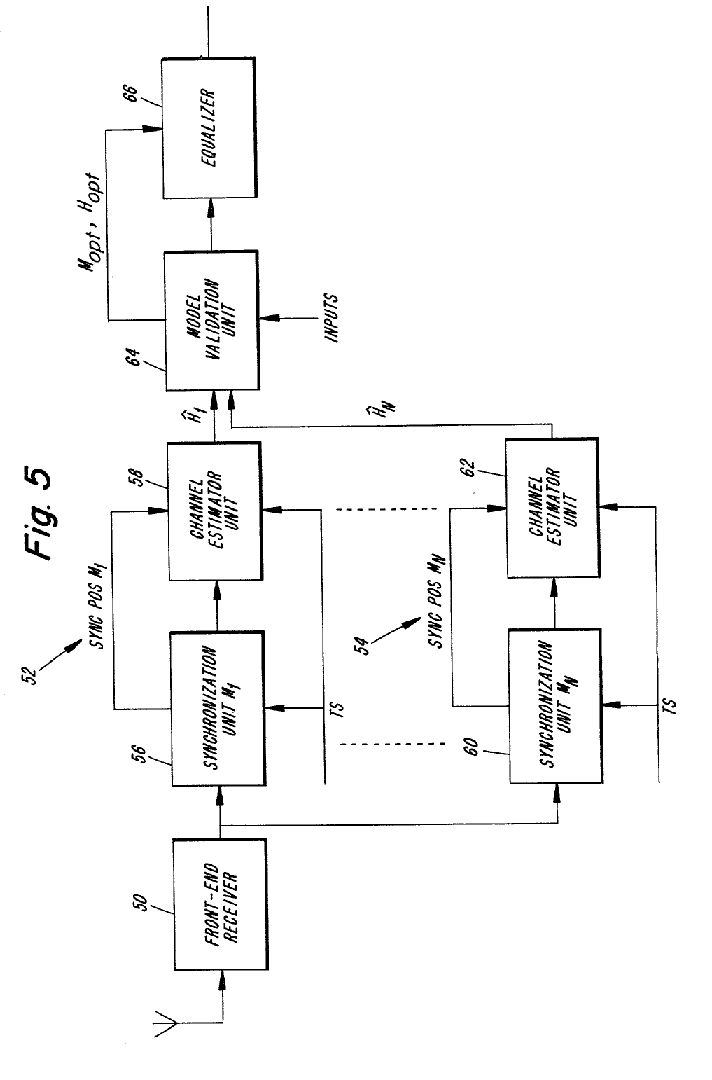

As mentioned above, these synchronization techniques have various strengths and weaknesses with respect to their ability to accurately determine the position of a known symbol pattern within a received burst depending upon radio channel conditions, which conditions will vary. Thus, according to exemplary embodiments of the present invention, a plurality of different synchronization techniques are used in processing the received signal so that accurate synchronization can be performed regardless of channel conditions. An example will be discussed below with respect to the exemplary receiver of FIG. 5.

Therein, a front-end portion 50 is again provided to downconvert the received signal to baseband. The resulting signal is then fed into a plurality of branches only two of which (generally referred to by numerals 52 and 54) are illustrated in FIG. 5, although those skilled in the art will appreciate that any number of branches can be provided, one for each combination of synchronization technique/channel model combination. Within each branch, taking branch 52 as exemplary, are a synchronization unit 56 and a channel estimation unit 58. The synchronization unit uses the locally generated version of the training sequence (TS) to determine a synchronization position for the received signal in accordance with one of the plurality of different synchronization techniques employed by receivers according to the present invention. For example, synchronization unit 56 can employ the correlation synchronization technique described above, while synchronization unit 60 employs the center of gravity synchronization unit described above. Each synchronization unit will synchronize to the received signal and output a synchronization position M to its respective channel estimation unit 58 or 62. That unit will determine a channel estimate based upon the inputs thereto and based upon a particular channel model associated therewith. The approaches to channel estimate per se are well known to those skilled in the art and, therefore, are not described in detail herein. In particular, the synchronization technique and channel model used in each branch can be paired to optimize the results, e.g., based upon simulations. For example, if the correlation technique is employed in synchronization unit 56, then a channel model associated with relatively high time dispersion can be used in channel estimation unit 58. Moreover, if the center of gravity technique is employed in synchronization unit 60, then a channel model having relatively less time dispersion can be used in channel estimation unit 62. Those skilled in the art will appreciate that there are may be many other different types of synchronization techniques than those explicitly described in these exemplary embodiments, which other techniques can also be implemented in accordance with the present invention, either by replacing those techniques described herein or by adding additional branches to the receiver illustrated in FIG. 5. For example, U.S. patent application Ser. No. 09/717,067, entitled “Joint Least Square Synchronization, Channel Estimation and Noise Estimation”, filed on Nov. 22, 2000 and U.S. Patent Application Serial No.______ entitled “A Determinant Based Synchronization Method”, also filed on Nov. 22, 2000, the disclosures of which are expressly incorporated here by reference, each describe additional techniques for synchronization which can be used in receivers in accordance with the present invention.

Regardless of the number and type of different synchronization techniques that are employed in receivers implemented in accordance with the present invention, the channel estimates from each branch are the provided to model validation unit 64 determines the best channel model for the current radio channel conditions and selects the corresponding channel estimate (and the corresponding synchronization position) for output to the equalizer 66. The model validation unit 64 uses certain input(s) to select the synchronization/channel estimate, e.g., information regarding one or more of: the amount of time dispersion currently being experienced on the radio channel, the estimated signal to noise ratio (SNR), the doppler frequency, the channel coding currently used on signal transmitted over the channel and the modulation currently used on the signal transmitted over the channel.

These inputs can be used in various ways to select a channel estimate/synchronization pair for output to equalizer 66. As an illustrative example, consider a thresholding test using one or more of the above described parameters. For example, if the SNR for channel model i<the SNR for channel model j AND the doppler frequency>a predetermined constant beta, then select model j and its channel estimate/synchronization point pair, otherwise select model i and its channel estimate/synchronization point pair. Those skilled in the art will appreciate that the foregoing is purely illustrative and that the implementation of an appropriate selection technique will vary depending upon the particular application of the present invention. The selection technique employed can be based on empirical studies, advanced mathematical or statistical models or the like. Another exemplary selection test can be found in U.S. patent application Ser. No. 09/168,605, entitled “Estimated Channel With Variable Number of Taps”, filed on Oct. 8, 1998, the disclosure of which is incorporated herein by reference.

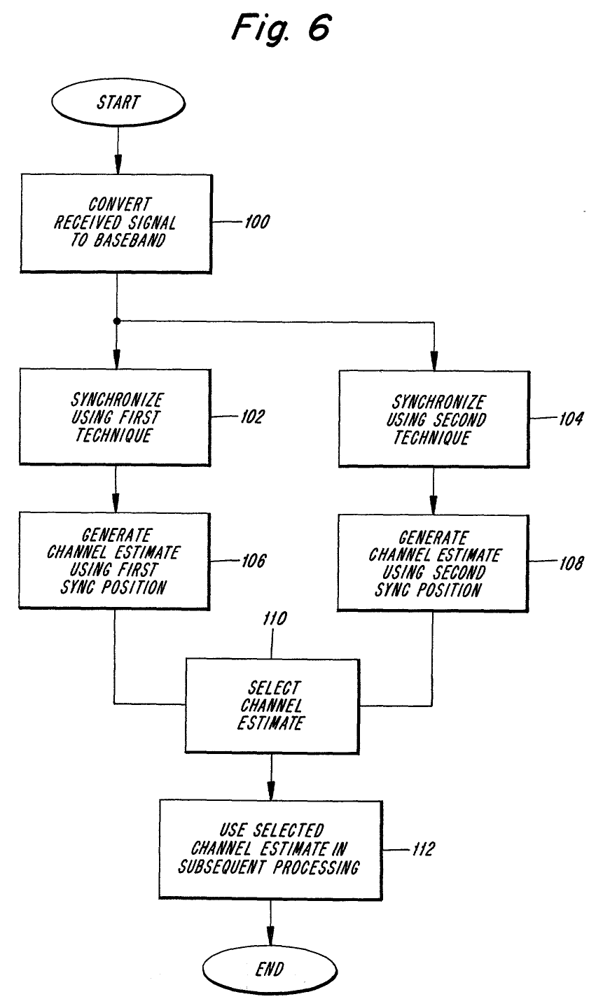

From the foregoing description, it will be apparent to those skilled in the art that the present invention provides receivers with the capability to more accurately synchronize to a radio signal in varying channel conditions, e.g., when the receiver is moving rapidly, when the receiver enters a structure, etc. The present invention is amenable to implementation in different ways that provide for different methods of signal processing, an example of which will now be described with respect to the flowchart of FIG. 6. Therein, a received signal is converted to baseband at step 100. Then, the baseband signal is provided to the different branches where, in parallel, the different synchronization techniques are applied as represented by steps 102 and 104. Each branch derives its own channel estimate, using the respective synchronization position, at steps 106 and 108. One of the channel estimates is selected, at step 110, e.g., based on current channel conditions such as the level of intersymbol interference. That channel estimate is then used, in step 112, for subsequent signal processing, e.g., equalization or, more generally, symbol detection.

The embodiments described above are merely given as examples and it should be understood that the invention is not limited thereto. It is of course possible to embody the invention in specific forms other than those described without departing from the spirit of the invention. Further modifications and improvements which retain the basic underlying principles disclosed and claimed herein, are within the spirit and scope of this invention.

What is claimed is:

1. A method for synchronizing to a radio signal comprising the steps of:
receiving said radio signal;
determining a first synchronization position for said radio signal using a first synchronization technique;
generating a first channel estimate using said first synchronization position;
determining a second synchronization position for said radio signal using a second synchronization technique, wherein said second synchronization technique is different from said first synchronization technique;
generating a second channel estimate using said second synchronization position; and
selecting one of said first channel estimate and said second channel estimate for use in subsequent processing of said radio signal.

2. The method of claim 1, wherein said step of determining said first synchronization position further comprises the steps of:
correlating said received radio signal to a known sequence to generate a plurality of correlations;
calculating an energy value by summing squared magnitudes of each of said correlations over a predetermined window; and
selecting, as said first synchronization position, a time value which maximizes said energy value.

3. The method of claim 1, wherein said step of determining said second synchronization position further comprises the steps of:
determining a mean position of a correlation function; and
selecting, as said second synchronization position, a time value which corresponds to said mean position.

4. The method of claim 1, wherein said step of selecting further comprises the step of:
selecting said first channel estimate if time dispersion associated with a radio channel over which said radio signal is received is above a threshold;
otherwise, selecting said second channel estimate position.

5. The method of claim 1, further comprising the step of:
using said selected channel estimate to equalize said received signal.

6. The method of claim 1, wherein said radio signal includes a plurality of frames, each of which includes a known sequence.

7. A receiver comprising:
means for receiving a radio signal;
means for determining a first synchronization position for said radio signal using a first synchronization technique;
means for generating a first channel estimate using said first synchronization position;
means for determining a second synchronization position for said radio signal using a second synchronization technique, wherein said second synchronization technique is different from said first synchronization technique;
means for generating a second channel estimate using said second synchronization position; and
means for selecting one of said first channel estimate and said second channel estimate for use in subsequent processing of said radio signal.

8. The receiver of claim 7, wherein said means for determining said first synchronization position further comprise:
means for correlating said received radio signal to a known sequence to generate a plurality of correlations;
means for calculating an energy value by summing squared magnitudes of each of said correlations over a predetermined window; and
means for selecting, as said first synchronization position, a time value which maximizes said energy value.

9. The receiver of claim 7, wherein said means for determining said second synchronization position further comprises:
means for determining a mean position of a correlation function; and
means for selecting, as said second synchronization position, a time value which corresponds to said mean position.

10. The receiver of claim 7, wherein said means for selecting further comprises:
means for selecting said first channel estimate if time dispersion associated with a radio channel over which said radio signal is received is above a threshold and, otherwise, selecting said second channel estimate position.

11. The receiver of claim 7, further comprising:
means for using said selected channel estimate to equalize said received signal.

12. The receiver of claim 7, wherein said radio signal includes a plurality of frames, each of which includes a known sequence.

13. The receiver of claim 7, wherein said receiver is disposed in a mobile station.

14. The receiver of claim 7, wherein said receiver is disposed in a base station.

15. A receiver comprising:
a downconverter for downconverting a received signal to baseband signal;
a known sequence generator for generating a synchronization sequence;
a first synchronization unit for synchronizing to said baseband signal using a first synchronization technique; and
a second synchronization unit for synchronizing to said baseband signal using a second synchronization technique, wherein said first synchronization technique and said second synchronization technique are different.

16. The receiver of claim 15, wherein said first synchronization unit further comprises:
a correlator for correlating said baseband radio signal to said synchronization sequence to generate a plurality of correlations;
a summer for summing squared magnitudes of each of said correlations over a predetermined window to generate an energy value; and
a processor for selecting, as a first synchronization position, a time value which maximizes said energy value.

17. The receiver of claim 15, wherein said second synchronization unit further comprises:
a correlator for correlating said baseband signal with said synchronization sequence to generate correlation values; and
a processor for determining a mean position associated with said correlation values and for selecting, as a second synchronization position, a time value which corresponds to said mean position.

18. The method of claim 1, wherein said step of selecting further comprises the step of:
selecting a corresponding one of said first synchronization position and said second synchronization position for use in said subsequent processing of said radio signal.

19. The receiver of claim 7, wherein said means for selecting further comprises:
means for selecting a corresponding one of said first synchronization position and said second synchronization position for use in said subsequent processing of said radio signal.
